(19) United States
(12) Patent Application Publication
(10) Pub. No.: US 2011/0267241 A1
(43) Pub. Date: Nov. 3, 2011

(54) Multi-Mission Frameless Airship Platform

(76) Inventors: Thomas Grimm, Corona del Mar, CA (US); Gregory T. Smedley, Aliso Viejo, CA (US); Reindy Allendra, Jakarta (ID); Kathryn A. Schubel, Corona del Mar, CA (US)

(21) Appl. No.: 13/099,385

(22) Filed: May 3, 2011

Related U.S. Application Data
(60) Provisional application No. 61/330,403, filed on May 3, 2010.

(51) Int. Cl. B64B 1/02; B64D 1/08; H01Q 1/28; B25J 18/00; F03D 9/00; B64B 1/08; B64B 1/22

(52) U.S. Cl. 343/706; 244/30; 244/25; 74/490.01; 290/55

(57) ABSTRACT

Multi-Mission Frameless Airship Platform (MFAP) leverages composite material science to achieve a frameless lightweight airframe design enabling increased speed, lift and cargo capacity. Deployable/retrievable high-value modules provide enhanced operational and mission flexibility. Unified power electronics enable hybrid integration of propulsion, power generation (e.g. diesel generator, photovoltaic solar, etc.), energy storage and tethered wind-power generation for both on-grid and off-grid electrical power delivery for airborne operations and ground operations. Onboard antenna systems serve as cell phone towers.

### CROSS REFERENCE TO RELATED APPLICATIONS

Provisional Application No. 61/330,403, filed on May 3,2010.

### BRIEF SUMMARY OF INVENTION

The present disclosure relates to a Multi-Mission Frameless Airship Platform (MFAP) that leverages composite material science to achieve a frameless airframe design enabling increased lift and cargo capacity. The MFAP design includes deployable and retrievable high-value modules, or gondolas, that provide enhanced operational and mission flexibility. Unified power electronics enable hybrid integration of propulsion, energy generation, storage and tethered wind-power generation for both on-grid and off-grid electrical power delivery for airborne (airship-based) operations and ground operations. On board antennae and communications systems can provide support for emergency disaster management, military operations, environmental monitoring or other missions.

### BACKGROUND OF INVENTION

Airships, dirigibles, blimps or aerostats are aircraft that remain aloft through the use of buoyant, lighter-than-air gases. The main structural component of an airship is a lightweight skin containing a lifting gas to which other components such as rudders, propellers, thrust mechanisms and other components are attached. The three main types of airships include non-rigid blimps that do not have an internal support framework, semi-rigid airships that have some form of internal support, and rigid airships with a full internal support framework. Non-rigid airships use pressure levels greater than the surrounding air pressure to retain their shape during flight. At sea level the internal flexible cells are filled with air. As altitude is increased, the lifting gas expands and air from the cells is expelled through air valves to maintain the same hull shape. To return to sea level, the process is reversed. Semi-rigid airships require internal pressure to maintain their shape, but have extended, usually articulated keel frames running along the bottom of the envelope to distribute suspension loads into the envelope and allow lower envelope pressures. Rigid airships have rigid frames containing non-pressurized gas cells to provide lift. Rigid airships do not depend on internal pressure to maintain their shape. Due to their limited speed, limited cargo capacity, and lack of maneuverability, traditional airships are not extensively used in emergency response and military operations except for surveillance and communication purposes.

### DETAILED DESCRIPTION OF THE INVENTION

The MFAP is a lighter-than-air airship comprising a plurality of primarily parallel, tubular, pneumatic cells, filled, pressurized and/or super-pressurized with a lifting gas. The MFAP can travel quickly to disaster areas, including locations not accessible by other modes of transportation and deliver emergency power to operations on the ground. Emergency power and communications are essential following natural and man-made disasters. Often essential power and communications are disrupted in emergencies due to damaged infrastructure, such as downed power lines, cell phone towers and power plants. Failure to communicate critical information to civilians and civil authorities combined with lack of power for critically needed services, such as emergency medical operations during an emergency that may last for extended periods of time, can be devastating. When communications and power break down during critical events, emergency response remains uncoordinated, too little arrives too late, and the cost is measured in human lives and an untold loss of essential, critically needed resources. Over the last decade billions of people have been affected by disasters, with extensive loss of life and costs that have soared into the trillions of dollars.

The MFAP's “Go Anywhere”—no landing site required—deployment capability can deliver emergency power, communications support and cargo, directly to any place where it is needed. Mission capabilities include rapid deployment of the MFAP faster than by ship, at lower cost than airlift and can be ready to operate immediately. From emergency response and relief, to military supply and support, to shoring construction materials for damaged infrastructure, the lightweight, highly maneuverable MFAP can be delivered into dense urban centers or remote landscapes, where roads may be impassable due to flooding, damaged bridges and roads; and

when the MFAP arrives in a deployment area in order to provide emergency power, the MFAP is tethered to a ground anchor, where MFAP-mounted wind turbines rotate in response to wind, generating electricity and electrical power is transferred down a tether to the ground for immediate use, or to a set of batteries for later use, or directly to the power grid; and

the MFAP can adjust its altitude to optimize wind power generation based on the variable wind speeds at different elevations and to avoid the adverse effects of low altitude ground turbulence or to reach stronger winds at higher altitudes, which prevail in the majority of the world's land mass, whereas only a small portion of land-areas have adequate wind near the ground suitable for conventional ground-based wind turbines; and

the aerodynamic shape of the MFAP frame is extremely stable in response to the wind, whereas alternative rotating lighter-than-air wind power generators are generally unstable; and

a multiplicity of wind energy conversion apparatus comprising various wind turbine systems, supported by wings or other extended supports from the airship frame are fitted to rotate in response to the wind when the MFAP is tethered to a ground anchor, while at the same time, the MFAP is oriented to point into the wind, so that the turbines are positioned to optimize the extraction of the maximum available wind energy; and in some embodiments, the MFAP can be shaped and wind turbines (and/or Pro/Gen units) positioned to enhance the airflow for the purpose of improving energy harvesting from the wind and/or propulsion.

the MFAP's dual purpose hybrid propulsion/power generation (Pro/Gen) system can alternatively propel the airship in flight or generate power when the airship is tethered to a ground anchor to support activities such as emergency response, relief, rescue and recovery operations on the ground; and

novel airframe wings affixed to the MFAP carry Pro/Gen propulsion systems that enhance the speed and reach of the MFAP from the point of origin to destination within theaters of operation, and the wings produce additional lift by moving through the air; and

the MFAP dual purpose Pro/Gen propulsion and wind turbine systems share unified power electronics; and

the Pro/Gen systems, may combine additional power generation systems, such as solar photovoltaic film attached to the external surface of the MFAP, which can be used as a primary, secondary, supplemental or hybrid source of electrical energy to substantially extend the MFAP mission duration, and enable broader, diverse, multi-mission capabilities; and

the MFAP power management system can also include an internal rechargeable energy storage system; and

the MFAP skin is comprised of ultra-high-molecular-weight, high-modulus polyethylene or similar material to form the airframe made up of pneumatic, tubular cells, seamed and welded together, and may form an internal honeycomb structure and extend the length of the airship; and

the MFAP skin material may incorporate an ultra-high strength nano-copolymer for additional tensile strength, tear resistance, impact resistance and puncture resistance to withstand deployment in harsh environmental conditions over a multi-year service life; and

during the manufacture of the MFAP skin, which may include an extrusion process, micro-grooves are engraved, pressed, laminated, fused, woven and/or stamped onto the surface of the external skin surface material to substantially reduce the skin-friction drag from the turbulent boundary-layer airflow where the longitudinal micro-grooves can constrain the airflow and limit the spanwise interaction, reducing drag; and

the MFAP's internal tubular, cellular honeycomb structure eliminates the need for an internal frame, dramatically reducing the weight of the airship while improving the airship's operational longevity and payload capacity; and

elongated pneumatic cushions are welded and/or splice seamed together around the exterior and throughout the interior to form a honeycomb-like structure in the interior of the MFAP to enhance body strength, cladding strength, load bearing strength, insulation properties, and balancing requirements of flexibility and rigidity; and

strips of material along the length of the tubular extruded pneumatic cells allow for an interleaved splice seam to fuse skin membrane fabrics of adjoining tubular cells, where spliced seams may be additionally welded together or welded to a lightweight metal or composite material frame that extends some or all of the length of the seam and may apply tape externally or internally to increase strength of the resultant seam; and

MFAP pneumatic cushions can be modified with additional laminated coatings of a variety of film treatments to control transparency, level of solar gain, and insulation properties; and

pneumatic cushions have high resistance to tearing and ability to work harden over a threefold+elongation range; and

the MFAP's pneumatic cushions have high resistance to large deflection forces caused by changes in temperature, heat, wind loading, internal structural support and external stress caused by tethering or other external factors; and

pneumatic cushions can serve as primary structural support or as a secondary structural support when the cushions are welded, fused or otherwise attached to composite, aluminum, or other structural framework constructed along the adjoining cushion seams; and

the pressurized pneumatic cushion construction can control solar shading and visual transparency; and

the pneumatic cushions can have a nested construction, in which one or more cushions are embedded within the interior of another cushion to enhance structural rigidity; and

the exterior pneumatic cushions can be coated, laminated or bonded on the inside, bottom layer with thin film photovoltaic (PV) cells/membranes; and

the exterior pneumatic pressurized cushions can be shaped to focus sunlight to increase photovoltaic power generation; and

the pneumatic cushions can be inflated with automatically adjustable internal lighter-than air gas pressure systems to insure lift and resistance to wind loads; and

the pneumatic cushions are transparent to communications onboard MFAP antennas; and

MFAP onboard high altitude antennas can replace several cell towers, critically needed in government civilian disaster emergency communications; and

MFAP onboard high resolution interactive display arrays can present emergency management and/or battlespace management visualizations for command and control by fusing multivariate, multidimensional data from satellites, UAVs and ground sensors into highly interactive displays, supported by airborne/sat/ground communications systems; and

MFAP visualization displays provide coherent mashups of vast amounts of data from disparate sources fused into an integrated collaborative decision space that improves critical analysis, threat mitigation, situational management and understanding prior to finalizing plans for more effective, rapid deployment of critically needed resources; and

information can be transmitted from the MFAP airborne communications system, unaffected by disaster conditions on the ground, directly to civil and military authorities, humanitarian relief organizations and various other emergency services; and

the MFAP can support military operations and provide communications support during large special events, such as the Olympic Games and World Cup; and

onboard ultra high resolution interactive display arrays can support airborne search and rescue capabilities; and

onboard high resolution interactive display arrays can support airborne intelligence, surveillance, reconnaissance (ISR) capabilities; and

onboard high resolution interactive display arrays can support wildfire command and control operations and search and rescue capabilities; and

aerial delivery systems are often used in emergency relief and military operations to deliver vital equipment and supplies from planes flying at varying altitudes to ground targets where problems associated with parachute cargo drops, such as parachute drift and hard landings may arise and whereas helicopters have limited range and cargo capacity and are not equipped to provide ongoing operational support on the ground, the MFAP can be deployed virtually anywhere, deliver cargo and deploy various service modules, such as self-contained emergency medical stations and emergency management communication centers linked to MFAP airborne communications; and

the MFAP's design includes deployable ground support service modules or gondolas, that can be retraced into the belly of the airframe or lowered to the ground by means of internal winches to deploy emergency medicine station modules, emergency management command and control operations modules or other service modules; and

emergency medical station modules or other service modules can be lowered to the ground on cables, where power is transmitted directly to the service modules by means of power cables from the MFAP; and

the deployable MFAP service modules or gondolas can function as passenger cabins and can be lowered while tethered or during low speed flight for environmental monitoring, filmmaking or tourism; and

the deployable modules or gondolas can include an observation deck that can be used for environmental monitoring, filmmaking or tourism; and

the MFAP tail section and/or other sections of the MFAP are equipped with multiple hinged robotic arms attached to a propeller or propellers, which are driven by an internal driveshaft connecting through the robotic arms to onboard motors; and

fleets of frameless airships can be airlifted or transported by other means in compact containers. Modular, extendable structures serve variable mission profiles with multi-ton cargo capacities.

### TECHNICAL BASIS FOR INNOVATION CLAIMS

Ultra-high-molecular-weight polyethylene material has been used in airships and is well suited for the welded, nested cellular structure. The nested pressurized pneumatic cellular airframe provides a highly rigid honeycomb internal structure eliminating the need for an internal frame or ballonet, thereby dramatically reducing the weight of the airship while improving the MFAP's operational speed and longevity while increasing its lift and payload capacity; and

the MFAP can be tethered at altitudes above 300 meters where wind is more consistent and blows at speeds generally greater than turbulent winds near ground level, so the available additional wind speed provides considerably more power for more reliable wind power generation;

the longitudinal micro-grooves on the surface of the MFAP's cellular exterior skin reduce the skin-friction drag from the turbulent boundary-layer airflow; and

deployable/retrievable high-value service modules can be retracted within the body of the ship during flight, lowered during safe speed flight and lowered to the ground to provide a wide range of enhanced operational flexibility to support missions such as emergency medical response, relief and recovery operations; and

onboard unified power electronics enable hybrid integration of propulsion/power generation turbines that can both propel the MFAP in flight and provide power generation when tethered for both on-grid and off-grid power delivery for airborne and ground deployed operations.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a profile view of the Multi-Mission Frameless Airship Platform

FIG. 2 is a perspective view of the Multi-Mission Frameless Airship Platform

FIG. 3 is a cutaway view of a tubular pneumatic cell

FIG. 4 is a perspective view of a tubular pneumatic cell showing ribbed surface

FIG. 5 is a cutaway view of two joined tubular pneumatic cells showing seam extensions

FIG. 6 is a perspective view of two joined tubular pneumatic cells showing seam extensions

FIG. 7 is a perspective view of a group of interconnected honeycomb tubular pneumatic cells

FIG. 8 is a cutaway view of the MFAP showing bundles of interconnected tubular pneumatic cells

FIG. 9 is a perspective view of a pair of multi-swivel, gimbaled, propulsion systems used to adjust the orientation of the propellers and direction of thrust of the airship

FIG. 10 is a schematic view of the MFAP hybrid Pro/Gen electrical power system

### DETAILED DESCRIPTION OF THE DRAWINGS

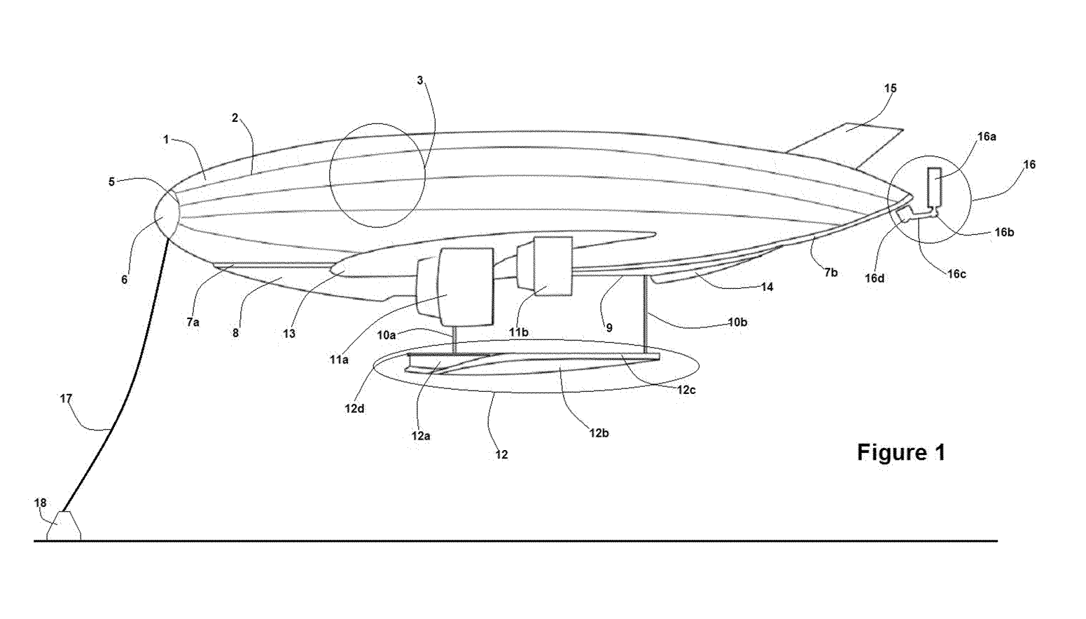

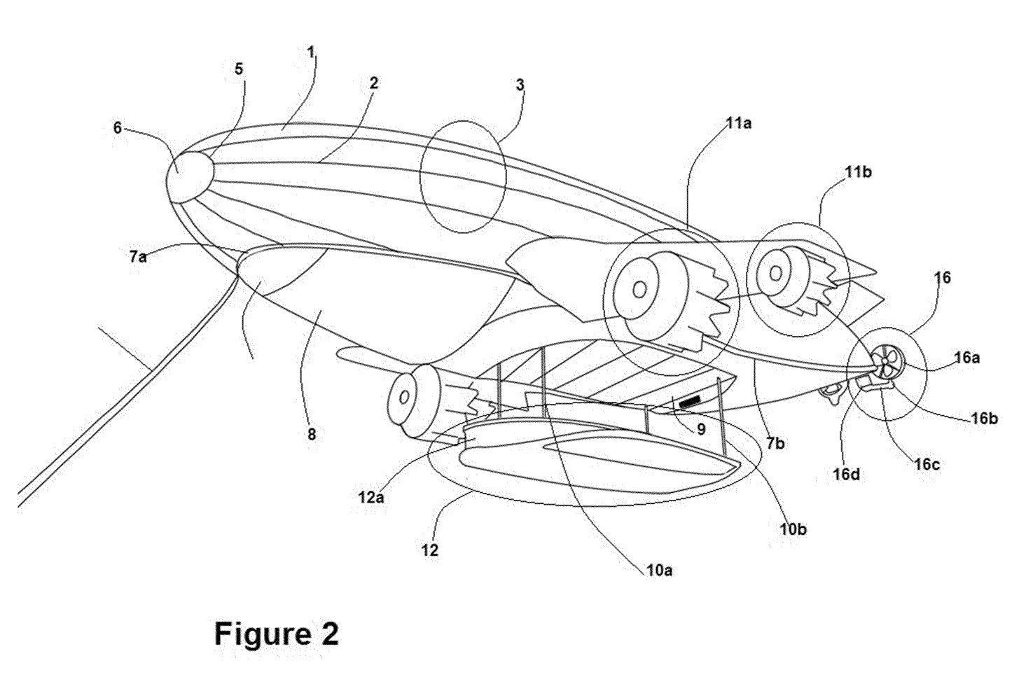

As shown in FIG. 1 and FIG. 2, an airship is illustrated in which the airframe of the airship is made up of a plurality of primarily parallel, tubular, pneumatic cells, filled, pressurized and/or super-pressurized with a lifting gas; and

tubular, pneumatic cells (1) filled, pressurized and/or super-pressurized with a lifting gas are aligned in a primarily parallel configuration and attached to each other by means of seams that are spliced, and/or welded and/or taped together (2) to form parallel aligned tubular cells (3) that are attached to a separate pneumatic nose cell (6) by a spliced and/or welded and or taped seam (5) and attached to the detachable, lightweight, hard-shell lower unit (8) along a seam (7a) and (7b) whereby service modules (12) can be lowered from the lower unit hold (9) and retracted back into the hold (9) by cables (10a) and (10b) attached to motorized winches; where the service modules (12) may have windshields (12a) service cabins (12b), support frames (12c) and observation decks (12d) can also be subdivided into various number of smaller modules or cargo containers that can be independently lowered by cables from the airship lower unit hold (9).

The airship in FIG. 1 is attached to a ground anchor (18) by means of a tether (17) that includes an internal or external power cable that connects to the airship's unified power electronics and to the airship's hybrid propulsion/power generation wind turbines (11a) and (11b) that can be comprised of a multiplicity of wind energy conversion apparatus consisting of various wind turbine systems that can be supported by wings (13) or other extended supports from the airship frame, and which can be oriented to rotate in response to the wind when the airship platform is tethered to a ground anchor, whereby the generated electricity can be used on the MFAP and/or stored in energy storage for later use and/or transferred down the tether (17) to the ground for immediate use, or to the power grid for distribution to other load centers; and

the propulsion system (16) of the airship in FIG. 1 and FIG. 2, which has multiple hinged (16b) and (16d) robotic arms (16c) that can readily orient the airship's propulsion thrust direction for tight quarter maneuvering where the attached propeller or propellers within propeller shield (16a) are driven by an internal driveshaft within the robotic arm (16c) connecting propellers through the robotic arms (16c) to internal motors on the airship or may be powered by integral motors in the propulsion system (16) frame (16a); and

the highly stable aerodynamic shape of the airship that serves as a high altitude wind power generation system that readily orients itself so as to point the nose of the airship into the wind, and is additionally stabilized when tethered to the ground or in flight by means of rear mounted fins (15) and a propulsion system that can be readily oriented to optimize the orientation of the wind generators with respect to the prevailing wind direction;

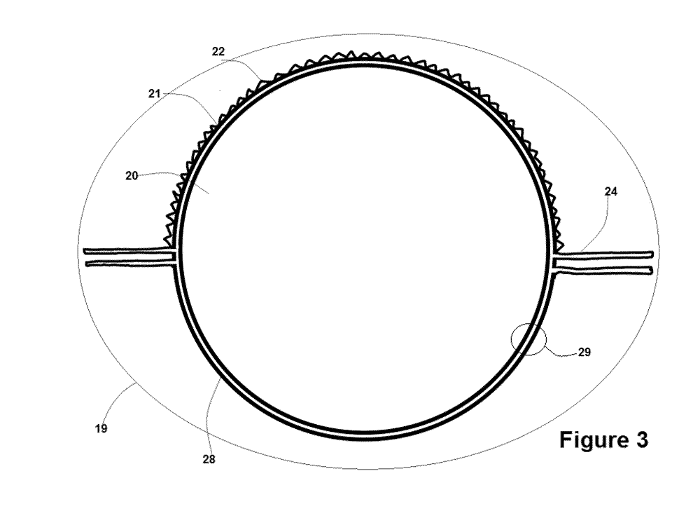

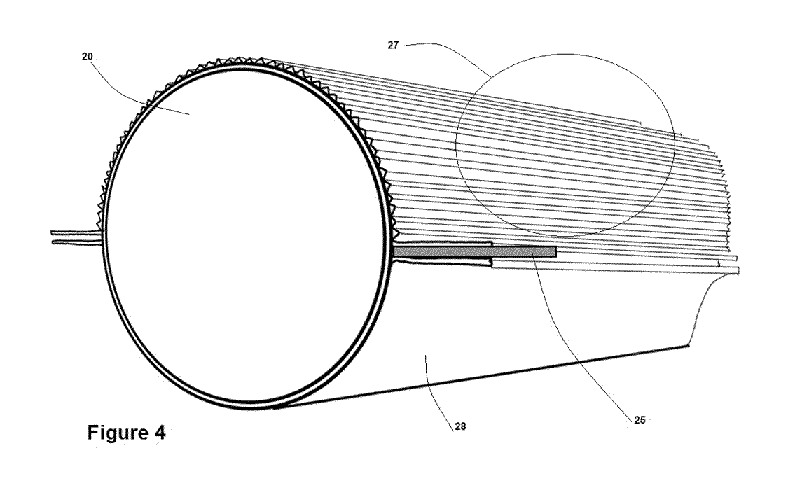

as shown in FIG. 3 and FIG. 4 a tubular, pneumatic cell (19) is made of an ultra-high-molecular-weight, high-modulus polyethylene (29) or similar material, is filled, pressurized and/or super-pressurized with a lifting gas (20) and the exterior surface (27) of the cell (19) that directly abuts the air and wind outside the airframe has micro-grooves, with elevated, raised areas (22) and depressed, grooved areas (21) that can be engraved, pressed, laminated, fused, woven and/or stamped onto the surface of the external skin surface material to reduce the skin-friction drag from the turbulent boundary-layer airflow where the longitudinal micro-grooves can constrain the airflow and limit the spanwise interaction, reducing drag;

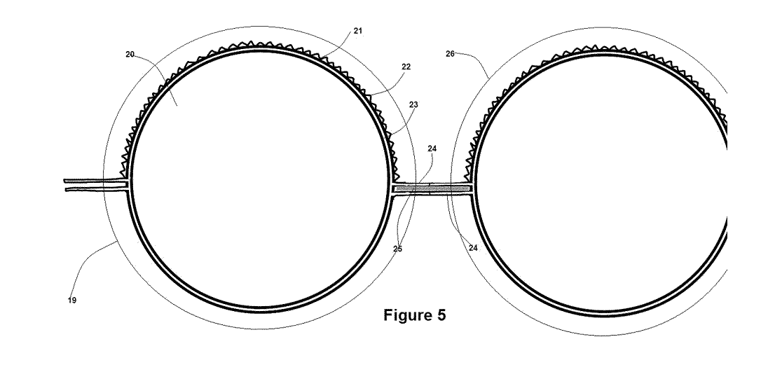

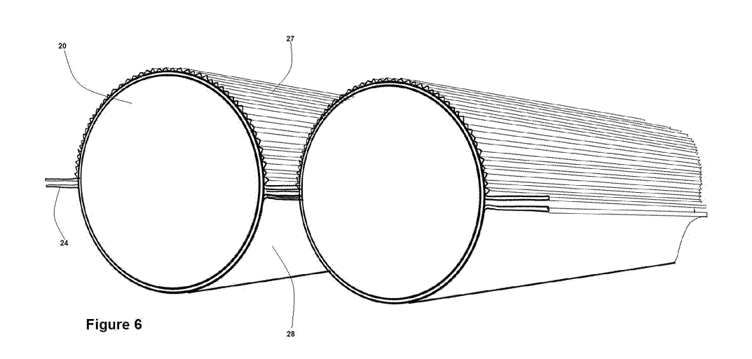

as shown in FIG. 4, FIG. 5 and FIG. 6, tubular pneumatic cells (19 and 26) have seam extensions (24) that are welded, and/or spliced seamed, and/or taped or fused together with adjacent cell seams or attached to a strut made of aluminum composite material (25) or similar lightweight material to form the body of an airship;

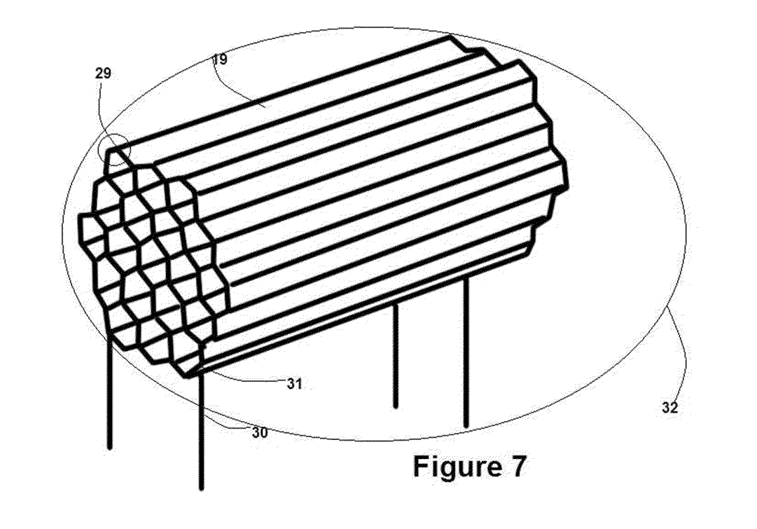

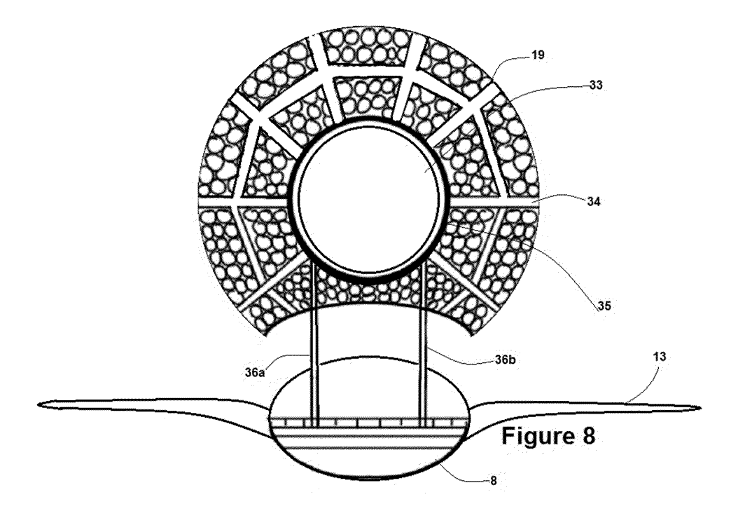

as shown in FIG. 7 and FIG. 8 a tubular honeycomb (32) of similar elongated pressurized pneumatic cells (19) within a portion of the airship or extending the entire length of the airship can be formed by a plurality of primarily parallel aligned tubular pneumatic cells, which substantially strengthens the structure of the airframe, eliminating the need for additional internal framework support, dramatically reducing the weight of the airship, enhancing cladding strength, insulation properties, and balancing requirements of flexibility and rigidity of the airship while improving the airship's operational longevity and payload capacity;

as shown in FIG. 7 and FIG. 8 additional internal structural struts (32) can be placed around the boundary between cells (19) or groups of honeycombed cells to enhance structural strength of the airframe and to serve as load bearing struts (30) that may be used to support the load of the detachable lower unit (8) as shown in FIG. 1, FIG. 2 and FIG. 8; and

as shown in FIG. 8 a large, internal pneumatic cell or variable size tube can be installed in the approximate center of the airframe, and extending a portion or entirely along the length of the interior of the airframe, where structural, load-bearing rings (35) of varying sizes are placed around the circumference of the internal central cell that can support load-bearing cables (36a) and (36b) that can be used to lower and raise the detachable lower unit (8) that can includes wings (13) and other components, such as wind power generation systems;.

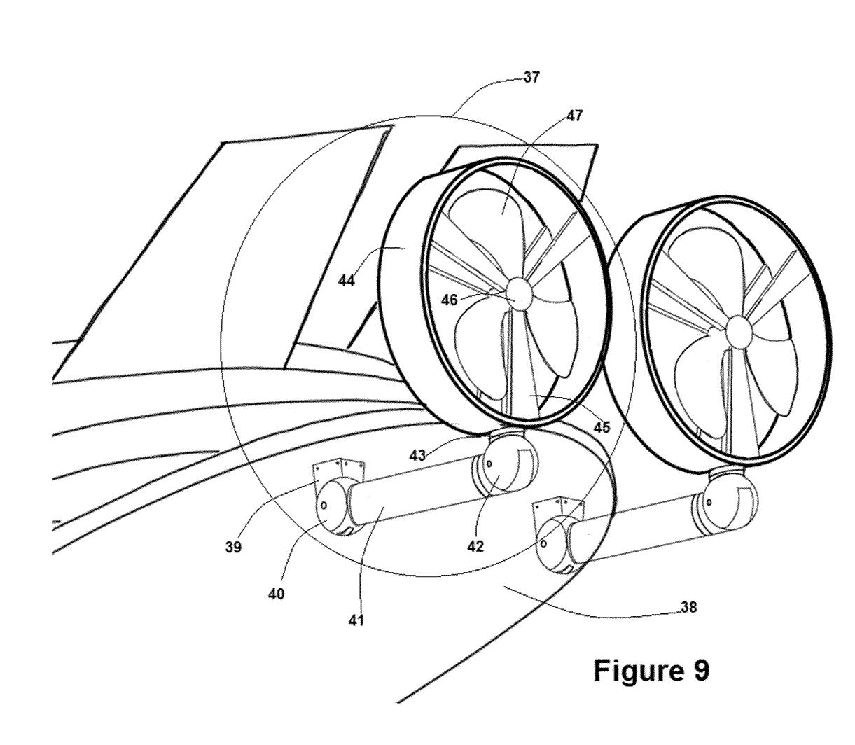

as shown in FIG. 9, a multi-swivel, gimbaled, robotic arm connects a propulsion system (37) to the body of the airframe (38) at assembly junction support (39) which attaches to a swivel hinge (40) which is attached by a rotatable strut (41) to swivel hinge (42) which is attached to a rotatable strut (43) where a driveshaft within the robotic arms (41) and (43) and hinges (40) and (42) are linked through fan blade shield (44) and propeller support shaft (45) to propeller axis coupling (46) which causes the propellers (47) to rotate at variable speeds, where the robotic arm assembly can adjust the orientation of the propellers and direction of thrust of the airship. Alternatively, the propellers (47) can be caused to rotate by an integrated electric motor in the propeller axis coupling (46) or the fan blade shield (44).

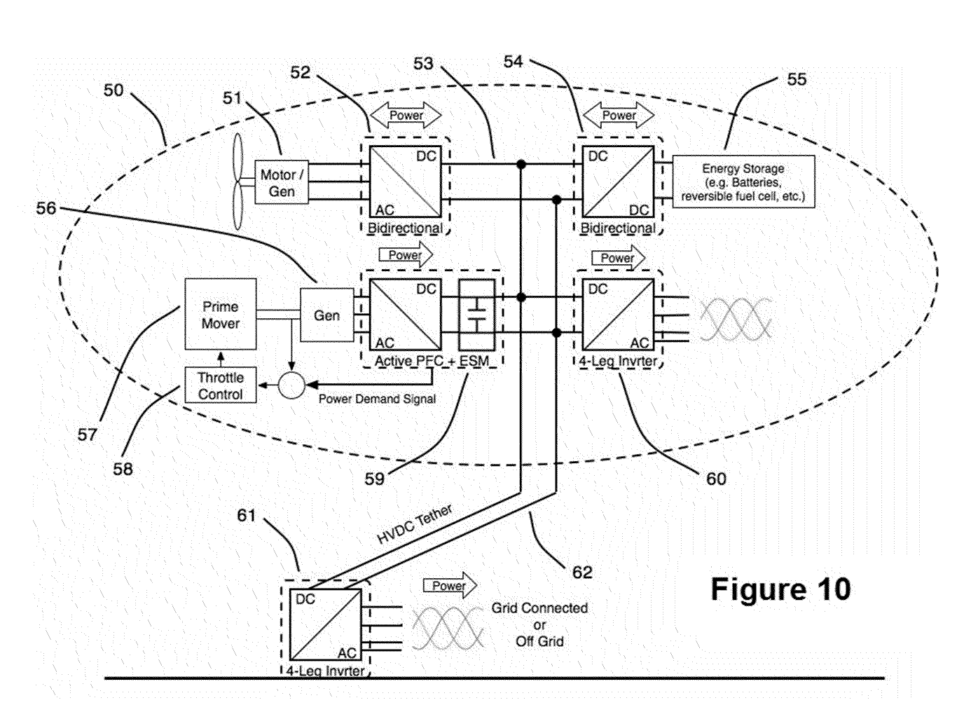

as shown in FIG. 10, a schematic of the multi-component hybrid propulsion/generation electrical system (50) with Pro/Gen unit or units (51), bidirectional AC/DC-DC/AC converter (52) to operate the Pro/Gen unit(s) (51) as a propulsion or wind generation units. A high-voltage DC (HVDC) bus architecture (53) that enable interconnection of the Pro/Gen units (51), energy storage (55), generator (56), and off-grid inverter (60) for on-board MFAP loads. The energy storage (55) is connected to the HVDC bus through a bidirectional DC/DC converter (54). The variable-speed load-following generator consisting of an electrical generator (56), a fuel-driven prime mover (57), a throttle control (58) provides on-board or tether power during flight or tethered operation as needed. The variable-speed load-following generator is connected to the HVDC bus through an AC/DC converter (59) that can include short-term energy storage to support transient load demands on the system. The HVDC bus (53) is further connected via a tether (62) to a ground-based DC/AC converter (61) that can serve power to ground-based off-grid loads or to the electrical grid for distribution to grid-connected loads as needed. Energy storage (55) can be used to enable silent watch operation, to provide propulsion power, or to optimize operation of the system.

1. An airship comprising primarily parallel, tubular, pneumatic cells filled, pressurized and/or super-pressurized with a lifting gas, made of ultra-high-molecular-weight, high-modulus polyethylene or similar material, and welded, spliced seamed, and/or taped or otherwise fused together, or struts made of high strength, lightweight aluminum composite or similar high strength, lightweight material to form the airframe of an airship that can include an internal tubular honeycomb of elongated pressurized pneumatic cells that extend a portion or the entire length of the airship, which substantially strengthens the structure of the airframe, eliminating to large measure the need for additional internal framework support, thereby reducing the weight of the airship, enhancing body strength, cladding strength, insulation properties and balancing requirements of flexibility and rigidity of the airship while improving the airship's operational longevity and payload capacity;

2. An airship that can quickly travel to a disaster area or other location by means of dual purpose hybrid airship propulsion/wind power generation (Pro/Gen) systems that can alternatively propel the airship in flight at enhanced speeds and generate power when the airship is tethered to a ground anchor;

3. The airship according to claim 2, wherein the power is generated by means of wind turbines that rotate in response to wind, thereby generating electrical energy and electrical power, which is transferred down a tether to the ground for immediate use, or to a set of batteries for later use, or to the power grid;

4. The airship according to claim 2, wherein its altitude can be adjusted based on the variable wind speeds at different elevations to avoid the adverse effects of low altitude ground turbulence or reach stronger winds at higher altitudes where more electrical power can be generated due to the stronger winds at such altitudes;

5. The airship according to claim 2, wherein the high altitude wind power generation system is highly stable aerodynamic shape that readily orients itself so as to point the nose of the airship into the wind, optimizing the orientation of the wind generators with respect to the prevailing wind direction whereby a multiplicity of wind energy conversion apparatus comprising various wind turbine designs, that can be supported by wings or other extended supports from the airship frame, which can be oriented to rotate in response to the wind when the host airship platform is tethered to a ground anchor;

6. The airship according to claim 2, wherein the propulsion system and wind power generation share unified power electronics between the integrated propulsion, power generation systems and additional power generation systems such as photovoltaic film, which can be used as a primary, secondary, supplemental or hybrid source of electrical energy to substantially extend the airship's mission duration, and broader, diverse, multi-mission capabilities;

7. The airship according to claim 1, wherein the skin material incorporates ultra-high strength nano-copolymer for additional tensile strength, tear resistance, impact resistance and puncture resistance to withstand deployment in harsh environmental conditions over a multi-year service life;

8. The airship according to claim 1, wherein the skin has micro-grooves engraved, pressed and/or stamped onto its external surface to reduce the skin-air friction drag from the turbulent boundary-layer airflow where the longitudinal micro-grooves can constrain the airflow and limit the spanwise interaction, reducing drag;

9. The airship according to claim 1, wherein the tubular pneumatic cushions make up the body of the airship can be modified with additional coatings of a variety of film treatments that control the cushion's transparency, which impacts the level of solar gain.

10. The airship according to claim 1, wherein the tubular pneumatic cushions make up the airframe of an airship serve as primary structural support or as a secondary structural support when the cushions are welded, fused or otherwise attached to composite aluminum framework constructed along the adjoining cushion seams;

11. The airship has disaster, emergency, or military response capability;

12. The airship according to claim 11, wherein the ship contains onboard airship high resolution interactive that display arrays present emergency management visualizations for emergency management command and control by fusing multivariate, multidimensional data from satellites, UAVs and ground sensors into highly interactive displays, to support various ground operations by providing coherent mashups of data from disparate sources fused into an integrated collaborative decision space that improves critical analysis, threat mitigation, situational management and understanding prior to finalizing plans for more effective, rapid deployment of critically needed resources;

13. The airship according to claim 11, wherein the airship can quickly travel to a disaster or other location and provide airborne cellular antenna services to replace cell phone towers that may be incapacitated, or provide cell phone tower services to areas without such services;

14. The airship according to claim 11, wherein the airship aerial delivery system can deliver cargo that is lowered by means of cables on airship winches, where the cargo containers are designed to conform to the shape of the underbelly of the airship and can be lowered and retraced back into the belly of the mother airship;

15. The airship according to claim 11, wherein the airship aerial delivery system can deploy various service modules, such as self-contained emergency medical stations and emergency management communication centers by means of cables on airship winches, where the service modules are designed to conform to the shape of the underbelly of the airship and can be lowered and retraced back into the belly of the airship;

16. An airship with deployable modules or gondolas that function as passenger cabins and can be lowered and retraced back into the belly of the airframe while the airship is tethered or when the airship is flying at safe speeds, to support environmental monitoring, filmmaking, sightseeing or other activities;

17. An airship propulsion system which has multiple hinged robotic arms that can orient the propulsion for tight quarter maneuvering whereby the propulsion system has multiple hinged robotic arms in which the attached propellers are driven by an internal driveshaft connecting the propellers through the robotic arms to internal or external motors on the airship;

18. A frameless airship with a detachable modular hard-shell lower body and wing assembly that attaches to a central core strut within the airframe, in which the central core strut extends the length of the ship from the nose to the tail of the airframe, as is surrounded and supported by a honeycomb of tubular, pneumatic cells aligned parallel to the central support strut;

19. A frameless airship with a detachable modular hard-shell lower body that has a hold in the lower portion of the body to accommodate modular service stations that can be lowered to the ground by means of cables and winches within the hard-shell unit.
